(19) United States
(12) Patent Application Publication
(10) Pub. No.: US 2018/0002189 A1
(43) Pub. Date: Jan. 4, 2018

(54) METHOD FOR PRODUCING GOLD NANOPARTICLES IN PLANTS AND GOLD NANOPARTICLES PRODUCED

(71) Applicant: UNIVERSIDAD DE SANTIAGO DE CHILE, Santiago (CL)

(72) Inventors: Antonio Castillo, Santiago (CL); Luis Cottet, Santiago (CL); Yanara Jaña, Santiago (CL)

(21) Appl. No.: 15/541,091

(22) PCT Filed: Dec. 30, 2015
(86) PCT No.: PCT/CL2015/050064

§ 371 Date: Jun. 30, 2017

(30) Foreign Application Priority Data
Dec. 31, 2014 (CL) 3620-2014
Dec. 31, 2014 (CL) 3622-2014
Dec. 31, 2014 (CL) 3623-2014
Dec. 31, 2014 (CL) 3624-2014
Dec. 31, 2014 (CL) 3625-2014

(51) Int. Cl. C01G 7/00; B01J 31/02

(52) U.S. Cl. CPC C01G 7/00; B01J 31/0209; B01J 31/0202; B01J 31/02; B01J 31/0204; B01J 2231/62; C01P 2004/64

(57) ABSTRACT

The present invention relates to the field of nanotechnology, more specifically to the production of gold nanoparticles (AuNPs) from plant extracts derived from leaves, stems, seeds, flowers, fruits or latex from plant species such as Colliguaja salicifolia, Pittosporum Undulatum, Acca sellowiana, Ugni molinae and Colliguaja integerrima, in which naturally occurring biocatalysts are possessed by these plants. The invention also relates to the gold nanoparticles obtained from said plants as well as to said natural biocatalysts.

### FIELD OF THE INVENTION

The present invention is related to the field of nanotechnology, more specifically to obtain nanostructures from plants and, particularly, providing a method to produce gold nanoparticles (AuNPs) from vegetable extracts derived from leaves, stems, seeds, flowers, fruits or latex from vegetable species, where natural biocatalysts from these plants act.

### BACKGROUND OF THE INVENTION

Metallic nanoparticles have several industrial applications, such as semiconductors manufacturing, photoluminescence, biomedicine, image obtention for medical diagnosis, as catalyzers, solar energy conversion, water treatments, cosmetics and treatments for some cancers, inter alia.

Gold and silver metallic nanoparticles (MNPs), are particles sized from 1 to 100 nanometers and are especially attractive because of their optical, chemical, mechanical, magnetic, catalytic and electric properties (Majdalawieh A, Kanan MC, El-Kadri O, Kanan S M. 2014. Recent advances in gold and silver nanoparticles: synthesis and applications. J Nanosci Nanotechnol. 14: 4757-4780.).

Synthesis of metallic nanoparticles from different compositions, geometry and size is a field of research in the nanotechnology field that has been of great interest in the last years. Currently, large scale gold nanoparticles (AuNPs) obtention is done by chemical means, which requires the use of reducing agents to generate the particles from soluble gold compounds. There is also physical methods, which require working at reduced pressures and high temperatures. In both cases, with the formation of AuNPs, toxic chemical compounds are generated, due to the reagents and operation conditions from the identified systems; these also present problems related with the stability, geometry, aggregation and control of the desired size of the generated nanoparticles (Sau T. K., Murphy C. J. 2004. Room temperature, high-yield synthesis of multiple shapes of gold nanoparticles in aqueous solution. J Am Chem Soc 126:8648-8649).

Given the worldwide relevance of the topic, it is absolutely necessary to implement alternative efficient methodologies to obtain metallic nanoparticles “environmentally friendly” and not requiring large amounts of energy. Thus, biologic systems are good candidates for it.

Currently, there are a great number of publications about the topic, specifically related with the ability of some organisms to generate these nanostructures, among which bacteria and fungus are mainly included (Sweet M J1, Chesser A, Singleton I. 2012. Review: metal-based nanoparticles; size, function, and areas for advancement in applied microbiology. Adv Appl Microbiol. 80:113-142). However, in the last years a great number of articles have been published demonstrating that different species have the ability to synthesize gold and silver nanoparticles Oyer R I, Panda T. 2014. Biogenic synthesis of gold and silver nanoparticles by seed plants. J Nanosci Nanotechnol. 14: 2024-2037).

In general, it is known that vegetable extracts have molecules such as flavonoids, triterpenoids, sesquiterpene glucosides, monoterpenes, diterpenes, vitamin C, flavones, tannins, phenols, polyphenols, glycosylated flavones and sugars. These molecules have the ability to reduce gold cations. Additionally, the biomolecules present in the extract, such as proteins and polysaccharides, have the ability to stabilize the generated nanoparticles.

At the level of intellectual property, patents related with the synthesis of metallic nanoparticles, mostly consist of using chemical methods to synthesize these structures, some of which allow obtaining particles with specific size and morphology. This is the case of patent U.S. Pat. No. 6,929,675 that describes a chemical system for generating copper, silver and gold nanoparticles. Regarding AuNPs specifically, it is also possible to find some publications, such as patent application US 20070125196 disclosing the synthesis of AuNPs with a size ranging from 30 to 90 nm using an aqueous medium containing sodium acrylate; as well as publication US 20060021468 describing a chemical method to control the uniformity of the generated particles.

On the other hand, Colliguaja salicifolia, also know as colliguay, from the Euphorbiaceae family is an endemic bush from Chile. It reaches a size from about 1.5 meters. It is found from the metropolitan Region to Magallanes region, is easy to grow and has certain medicinal value. Studies regarding the chemical composition of Colliguaja salicifolia showed a content of flavonoids and triterpenoids (Bittner M, Alarcón J, Aqueveque P, Becerra J, Hernández V, Hoeneisen M, Silva M. 2001. Estudio químico de especies de la familia Euphorbiaceae en Chile. Bol Soc Chil Quín. 46:1-13).

Pittosporum undulatum is a tree reaching a height of up to 15 meters and belong to the Pittosporaceae family. It is originally from Australia, but has expanded thanks to its great adaptability to adverse conditions, becoming a pest in some parts of the world. It produces orange globular fruits (Medeiros J R, Campos L B, Mendonça S C, Davin L B, Lewis N G. 2003. Composition and antimicrobial activity of the essential oils from invasive species of the Azores, Hedychium gardnerianum and Pittosporum undulatum. Phytochemistry 64: 561-565). The fruit, leaves and seed from this tree have sesquiterpenes glucosides such as guayano, monoterpenes, diterpenes and alkanes that could be involved in the reduction and stabilization of MNPs (Mendes S, Mansoor T, Rodrigues A, Armas J B, Ferreira M J. 2013. Anti-inflammatory guaiane-type sesquiterpenes from the fruits of Pittosporum undulatum. Phytochemistry 95: 308-314; Sadgrove J N, Jones G. 2013. Chemical and biological characterization of solvent extracts and essential oils from leaves and fruit of two Australian species of Pittosporum “Pittosporaceae” used in aboriginal medicinal practice. J Ethnopharmacol 145: 813-821).

Acca sellowianna, also known as guayabo, is a bush from the Myrtaceae family. It is from the higher areas from Brazil, Uruguay, Colombia, Bolivia, Argentina y Paraguay, thus resisting the cold well, but not the high temperatures. It produces a fruit known as Feijoa, having a great edible value (El-Shenawya S, Marzoukb M, El Dib R, Elyazed H, Shaffie N, Moharram F. 2008. Polyphenols and Biological activities of Feijoa Sellowiana leaves and twigs. Rev Latinoam Quim. 3: 103-120; Ross S, Grasso R. 2010. In vitro propagation of “Guayabo del país” Acca sellowiana Berg. Burret. Fruit Veg Cereal Sci Biotech. 4: 83-87) having significative amounts of iodine, a significative amount of vitamin C, flavones and tannins (Keller H, Tressens S. 2007. Presencia en Argentina de dos especies de use múltiple: Acca sellowiana “Myrtaceae” y Casearia lisiophilla “Flacourtiacea”. Darwiniana. 45: 204-212; EI-Shenawya S, Marzoukb M, El Dib R, Elyazed H, Shaffie N, Moharram F. 2008. Polyphenols and Biological activities of Feijoa Sellowiana leaves and twigs. Rev Latinoam Quim. 3: 103-120).

Ugni molinae, also known as Murta or Murtilla, it is a bush from the Myrtaceae family reaching a high from 1 to 2 meters. It grows in Chile from the Metropolitan Region to the Aisén Region, and in some zones of Argentina bordering Chile. Is a plant relatively easy to grow and used in medicinal ways and edible, because of the fruit it produces (Doll U, Rodriguez I, Soto C, Razmilic I. 2012. Propagación de estacas y concentración de taninos y flavonoides en hojas de dos procedencias de Ugni molinae de la región del Maule, Chile. Bosque. 33: 203-209). Leaves have polyphenols such as flavonoids and tannins, besides triterpenoids (Avello M, Pastene E. 2005. Actividad antioxidante de infusos de Ugni molinae Turcz “Murtilla”. BLACPMA 4: 33-39; Rubilar M, Pinelo M, Ihl M, Scheuermann E, Sineiro J, Nuñez M J. 2006. Murta Leaves “Ugni molinae Turcz” as a Source of Antioxidant Polyphenols. J. Agric. Food Chem. 54: 59-64; Doll U, Rodriguez I, Soto C, Razmilic I. 2012. Propagación de estacas y concentración de taninos y flavonoides en hojas de dos procedencias de Ugni molinae de la región del Maule, Chile. Bosque. 33: 203-209) and the fruit has a great amount of polyphenols such as flavones, glycosylated flavones and sugars (Rubilar M, Pinelo M, Ihl M, Scheuermann E, Sineiro J, Nun\tilde{e}z M J. 2006. Murta Leaves “Ugni molinae Turcz” as a Source of Antioxidant Polyphenols. J. Agric. Food Chem. 54: 59-64; Shene C, Canquil N, Jorquera M, Pinelo M, Rubilar M, Acevedo F, Vergara C, von Baer D, Mardones C. 2012. In vitro Activity on Human Gut Bacteria of Murta Leaf Extracts “Ugni molinae” turcz. a Native Plant from Southern Chile. J Food Sci. 77: 323-329).

Coffiguaja integerrima, also known as colliguay or coliguay, from the Euphorbiaceae family is an evergreen bush located in Chile and some neighboring areas of Argentina. It can reach heights of up to 2 meters, is easy to grow and has some medicinal value. Studies regarding the chemical composition of Colliguaja integerrima showed a content of flavonoids and phenolic compounds (Bittner M, Alarcón J, Aqueveque P, Becerra J, Hernández V, Hoeneisen M, Silva M. 2001. Estudio químico de especies de la familia Euphorbiaceae en Chile. Bol Soc Chil Quím. 46:1-13).

Considering the biochemical composition of the previous species, it was thought that organic molecules from its vegetable tissues could be used as biological catalyzers to reduce soluble metallic cations to its elemental state; step considered critical in the generation of nanoparticles.

Currently, there are no studies in the field of nanotechnology using leaves, stems, seeds, flowers, fruits or latex extracts from vegetable species Colliguaja salicifolia, Pittosporum undulatum, Acca sellowianna, Ugni molinae or Colliguaja integerrima in the synthetic process of metallic nanoparticles.

### SUMMARY OF THE INVENTION

From the research performed by the applicants, it was demonstrated that the aqueous extracts from the vegetable species Colliguaja salicifolia, Pittosporum undulatum, Acca sellowianna, Ugni molinae and Colliguaja integerrima have the ability to catalyze the synthesis of gold nanoparticles at room temperature starting from a HAuCl4 solution. Nanoparticle formation was verified following the color change from pale yellow to reddish or purple. Additionally, solutions containing the nanoparticles showed a maximum absorbance of 540 nm, corresponding to the surface plasmon resonance characteristic of the presence of these types of nanostructures.

Thus, the present invention relates to obtaining AuNPs from aqueous vegetable extracts from leaves, stems, seeds, flowers, fruits or latex from the Colliguaja salicifolia, Pittosporum undulatum, Acca sellowianna, Ugni molinae or Colliguaja integerrima species and/or to molecular biocatalyst produced intra or extracellularly in this plants where this biocatalysts mediate these metallic cations reduction reactions, and the gold nanoparticles from these plants by the method of the invention. It is for the above that the process can be performed using the plant directly or molecules that have been isolated from them.

In particular, the present invention relates to a method of obtaining the gold nanoparticles from plants, wherein the method comprises the steps of:
a) to obtain a plant extract;
b) to heat said extract;
c) to eliminate the insoluble material from said extract;
d) to mix, under appropriate conditions, the soluble material from the extract with a substrate comprising a gold salt; and
e) to recover the gold nanoparticles from said admixture.

In a preferred embodiment of the method of the invention, said vegetable extract is an aqueous extract and is obtained by macerating any part of the selected plant such as seeds, stems, flowers, leaves, fruits, latex or a combination thereof.

In another preferred embodiment of the invention, the vegetable extract is heated to boiling point for about 1 to 10 minutes, and the resulting insoluble material is eliminated by filtration.

In the method of the invention, preferably the gold salt used is HAuCl4.3H2O.

The preferred appropriate conditions to mix the soluble material from the vegetable extract with the gold salt is to keep a mix of both components for 0.5 to 12 hours, at a temperature between 25-27° C.

In another preferred embodiment of the invention, the gold nanoparticles are recovered from the previous admixture by centrifugation at low speed or by sedimentation by standing the mixture for at least 1 hour.

The invention also refers to gold nanoparticles obtained by the method previously described in the vegetable species Colliguaja salicifolia, Pittosporum undulatum, Acca sellowianna, Ugni molinae or Colliguaja integérrima which are characterized as follow:
when obtained from Colliguaja salicifolia and Acca sellowianna, these nanoparticles have a triangular, pentagonal, hexagonal, polyhedral or spheroidal geometry and a diameter between 10 nm and 100 nm;
when obtained from Pittosporum undulatum, they have a spheroidal geometry and a diameter between 5 nm and 10 nm;
when obtained from Ugni molinae they have a triangular, cubic, hexagonal, polyhedral or spheroidal geometry and a diameter between 5 nm and 200 nm;
when obtained from Colliguaja integerrima, they have a triangular, pentagonal, hexagonal, polyhedral or spheroidal geometry and a diameter between 10 nm and 150 nm.

Natural molecules used as biocatalysts to obtain gold nanoparticles from plants are also considered within the scope of this invention. These can also be isolated from the vegetable extracts of these vegetable species and can be used with this same purpose. Within these molecules are phenolic compounds such as flavonoids, tannins, as well as triterpenoids, glucosides, sesquiterpenes, monoterpenes, diterpenes, alkanes and vitamin C.

### BRIEF DESCRIPTION OF THE FIGURES

FIG. 1. Represents the UV-visible spectrum from AuNPs synthesized from the Colliguaja salicifolia leaves vegetable extract. (▴) curve generated by AuNPs suspension. (▪) curve generated by the HAuCl₄ substrate. () curve generated by the leave extract from Colliguaja salicifolia.

FIG. 2. Represents the UV-visible spectrum from AuNPs synthesized from the Pittosporum undulatum seeds extract: (▴) curve generated by AuNPs suspension. (▪) curve generated by the HAuCl₄ substrate. () curve generated by the extract of Pittosporum undulatum seeds.

FIG. 3. Represents the UV-visible spectrum from the synthesized AuNPs from the Pittosporum undulatum leaves extract. (▴) curve generated by AuNPs suspension. (▪) curve generated by the HAuCl₄ substrate. () curve generated by the extract of Pittosporum undulatum leaves.

FIG. 4. Represents the UV-visible spectrum from the synthesized AuNPs from the Feijoa pericarpium from Acca sellowiana vegetable extract. (▴) curve generated by AuNPs suspension. (▪) curve generated by the HAuCl₄ substrate. () curve generated by the extract of Feijoa from Acca sellowiana pericarpium.

FIG. 5. Represents the UV-visible spectrum from the synthesized AuNPs from the Feijoa mesocarp from Acca sellowiana vegetable extract. (▴) curve generated by AuNPs suspension. (▪) curve generated by the HAuCl₄ substrate. () curve generated by the Feijoa mesocarp from Acca sellowiana extract.

FIG. 6. Represents the UV-visible spectrum from the synthesized AuNPs from the Ugni molinae fruits vegetable extract. (▴) curve generated by AuNPs suspension. (▪) curve generated by the HAuCl₄ substrate. () curve generated by the Ugni molinae fruits vegetable extract.

FIG. 7. Represents the UV-visible spectrum from the synthesized AuNPs from the vegetable extract of Colliguaja integerrima leaves. (▴) curve generated by AuNPs suspension. (▪) curve generated by the HAuCl₄ substrate. () curve generated by the Colliguaja integerrima leaves vegetable extract.

FIG. 8. Shows a microphotograph of AuNPs from the Coffiguaja salicifolia leaves vegetable extract taken at a magnification of 60.000× using tetrachloroauric acid as a substrate. The bar at the right lower side represents 200 nm.

FIG. 9. Shows a microphotograph of AuNPs from the Pittosporum undulatum seeds vegetable extract taken at a magnification of 60.000× using tetrachloroauric acid as a substrate. The bar at the right lower side represents 200 nm.

FIG. 10. Shows a microphotograph of AuNPs from the Pittosporum undulatum leaves vegetable extract, taken at a magnification of 60.000× using tetrachloroauric acid as a substrate. The bar at the right lower side represents 200 nm.

FIG. 11. Shows a microphotograph of AuNPs from the Feijoa pericarpium from Acca sellowiana extract, taken at a magnification of 60.000× using tetrachloroauric acid as a substrate. The bar at the right lower side represents 200 nm.

FIG. 12. Shows a microphotograph of AuNPs from the Feijoa mesocarp from Acca sellowiana extract, taken at a magnification of 60.000× using tetrachloroauric acid as a substrate. The bar at the right lower side represents 200 nm

FIG. 13. Shows a microphotograph of AuNPs from the Ugni molinae fruits extract, taken at a magnification of 87.000× using tetrachloroauric acid as a substrate. The bar at the right lower side represents 200 nm.

FIG. 14. Shows a microphotograph of AuNPs from the Colliguaja integerrima leaves extract, taken at a magnification of 87.000× using tetrachloroauric acid as a substrate. The bar at the right lower side represents 200 nm.

### DETAILED DESCRIPTION OF THE INVENTION

Hereinafter the invention will be described in detailed making emphasis in examples of use of the different vegetable species previously listed. It must be understood that said examples are illustrative and are intended to provide a better understanding of the details of the invention, but do not limit the scope thereof.

### EXAMPLES

### Example 1: Vegetable Extract Preparation

To obtain the vegetable extract the following steps were followed:
for Colliguaja salicifolia, 4 g of leaves or stems are weighted.
for Pittosporum undulatum, 4 g of seeds, leaves, stems or fruits are weighted.
for Acca sellowiana, 4 g of pericarpium, mesocarp, stems, leaves, seeds or flowers are weighted.
for Ugni molinae 4 g of fruits, stems, leaves, seeds or flowers are weighted.
for Colliguaja integerrima 4 g of leaves or stems are weighted.

In all cases, the selected parts are washed with distilled water and then macerated in a mortar to separate the liquid from the solid fraction. 100 mL of distilled water are added to the later fraction and heat is applied until boiling. Both samples, the liquid fraction obtained by maceration and the resulting from the heating at 100° C., are filtrated to eliminate the insoluble particles and are stored to later use.

Alternatively, to obtain the extract, 500 μL of latex from Colliguaja salicifolia or from Colliguaja integerrima are diluted until reaching 100 mL with distilled water. The mixture is heated until boiling, filtered to eliminate the insoluble particles, and used immediately or conveniently stored.

### Example 2: Production of Metallic Nanoparticles

Metallic nanoparticle synthesis was performed adding the corresponding metallic substrate directly over the solution containing the molecules from the vegetable extract. In this case, to form the gold nanoparticles (AuNPs) tetrachloroauric acid trihydrate (HAuCl₄.3H₂O) was used. The proportion of reactants used was 1:4, adding 200 μL of extract and 800 μL of 1 mM solution of metallic substrate and completing a 1 mL volume.

### Example 3: Characterization of Metallic Nanoparticles

### a) Visual Characterization

Initial determination of nanoparticle formation was performed watching the color change of the solution containing the vegetable extract and the corresponding metallic substrate. When AuNPs formation happens, the solution turns purple-violet, characteristic color of the nanoparticle formation.

When mixing the Colliguaja salicifolia vegetable extract with tetrachloroauric acid, the AuNPs formation was detected by the color change from yellow-greenish to violet-purplish, characteristic of the AuNPs presence.

On the other hand, when mixing the Pittosporum undulatum seed or fruit extract with tetrachloroauric acid, AuNPs formation was detected by the color change from yellow to dark violet, while, with the leaves or stems extracts, the color change was from light yellow to dark pink, typical colors of AuNPs presence.

Additionally, when mixing the pericarpium or mesocarp extract from the Acca sellowiana fruit with tetrachloroauric acid, AuNPs formation was detected by the color change from light yellow to violet, characteristic of the AuNPs presence.

Furthermore, when mixing the Ugni molinae fruits extract with tetrachloroauric acid, the AuNPs formation was detected by the color change from pale pink to violet, characteristic of the AuNPs presence.

When mixing the Colliguaja integerrima vegetable extract with tetrachloroauric acid, AuNPs formation was detected by the color change from light yellow to bluish violet, characteristic of the AuNPs presence.

### b) UV-Visible Spectroscopy

This technique was used to perform the samples qualitative analysis, as the absorbance peak or maximum of the particulate material suspension, can be related with the nanoparticle shape and size. This is possible because different metals nanoparticles have a maximum peak of absorbance in the UV-Visible spectrum with a wavelength (λ) characteristic of each one of them. In the case of AuNPs, a peak with a maximum absorbance between 500 and 550 nm is obtained.

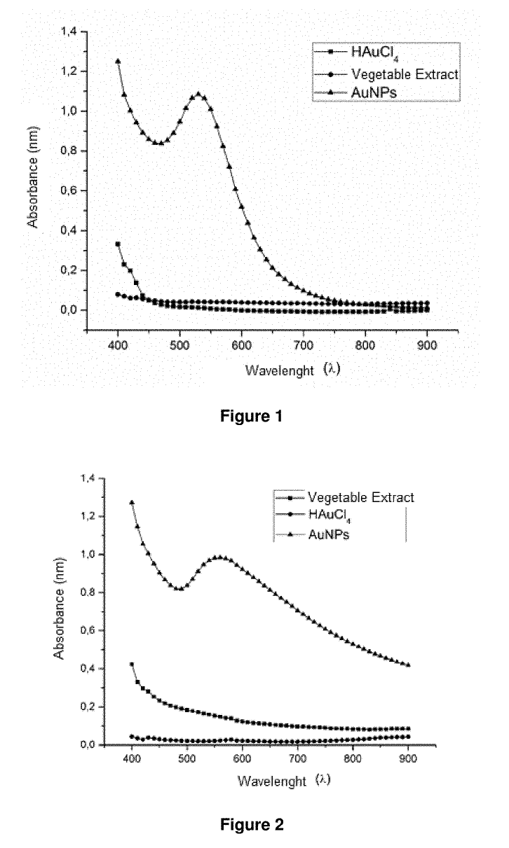

In FIG. 1 a UV-Visible absorption peak for the AuNPs obtained using the Colliguaja salicifolia vegetable extract. The band of the surface plasmon resonance for the AuNPs formed by the Colliguaja salicifolia vegetable extract was obtained at 530 nm, showing a clear absorbance peak at this wavelength, while the curves obtained with the substrate or with the vegetable extract do not present absorbance variations in the range of the determined wavelengths.

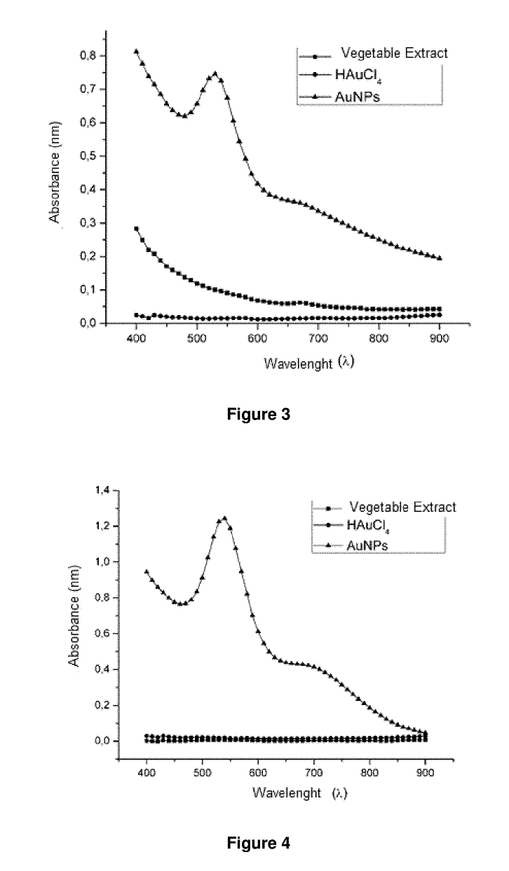

In FIG. 2 it is possible to observe the UV-Visible spectrum for the AuNPs obtained using the Pittosporum undulatum seeds or fruits extract. The band of surface plasmon resonance for the AuNPs formed by the Pittosporum undulatum fruits or seeds extract was obtained at 560 nm. On the other hand, in FIG. 3 the UV-visible absorption spectrum for the AuNPs obtained using the Pittosporum undulatum leaves or stems extract. In this case, the spectrum shows a maximum absorbance of 530 nm. In both cases very defined absorbance peaks are observed at these wavelengths. The control curves obtained with the substrate or with the vegetable extract, do not presented absorbance variations in the range of the determined wavelengths.

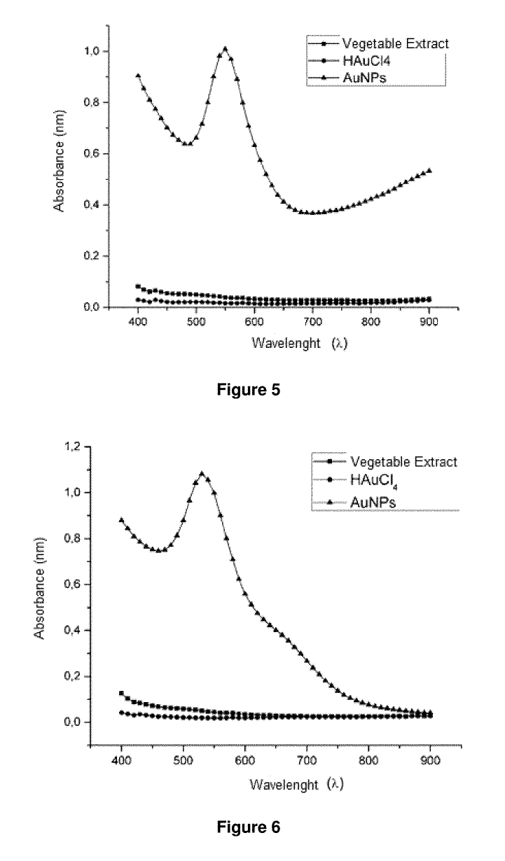

In FIGS. 4 and 5 it is possible to observe the UV-visible absorption spectra for the AuNPs obtained from the pericarpium and mesocarp of the Acca sellowiana fruit extract, respectively. The surface plasmon resonance bands for the AuNPs formed by the Acca sellowiana pericarpium and mesocarp fruit extract were obtained at 540 and 550 nm, respectively, observing a clear absorbance peak at these wavelengths, while the curves obtained with the substrate or the vegetable extract, did not present absorbance variations in the range of the determined wavelengths.

In FIG. 6 it is possible to observe the UV-visible absorption spectrum of AuNPs obtained using the Ugni molinae fruits extract. The surface plasmon resonance band for the AuNPs formed by the Ugni molinae fruits extract was obtained at 530 nm, showing a clear absorbance peak at this wavelength, while the curves obtained with the substrate or the vegetable extract do not show absorbance variation in the range of the determined wavelengths. Similar results were obtained with Ugni molinae seeds, leaves, flowers and stems extracts.

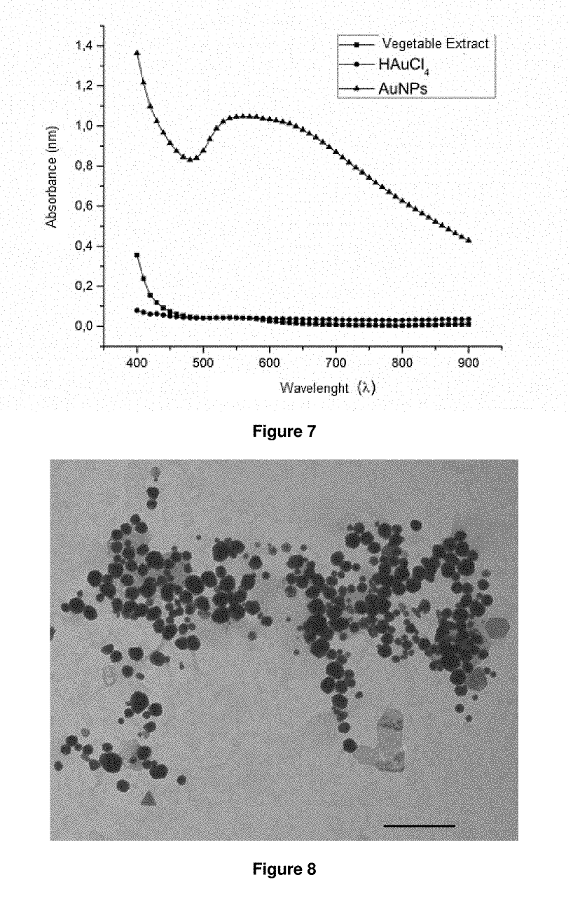

In FIG. 7, it is possible to observe a UV-Visible spectrum for the AuNPs obtained using a Colliguaja integerrima leaves extract. The surface plasmon resonance band for the AuNPs formed by the Colliguaja integerrima leaves extract was obtained at 560 nm, observing a clear absorbance peak at this wavelength.

In FIGS. 1 to 7 it is possible to additionally observe that the UV-visible absorption curves obtained with the substrate or the vegetable extract, do not present absorbance variation in the range of the considered wavelengths:

The previous results confirm that the extracts obtained from Colliguaja salicifolia, Pittosporum undulatum, Acca sellowiana, Ugni molinae or Colliguaja integerrima species catalyze the synthesis of AuNPs, when tetrachloroauric acid is used as a substrate, in the used reaction conditions.

### c) Transmission Electronic Microscopy

This technique was used to visualize the geometric shape and to determine the size of the metallic nanoparticles. It was also used to make an approximate estimation of the MNPs size distribution. To do so, nanoparticle solution aliquots are deposited over 200 mesh copper grids with formvar and carbon. Gold nanoparticle suspensions were observed in a Philips Tecnai 12 Bio Twin transmission electronic microscopy at 80 kV.

In FIG. 8 it is possible to observe the nanoparticles obtained using the Colliguaja salicifolia extract. These nanostructures present a great diversity in shapes and sizes. It is possible to observe triangular, pentagonal, hexagonal, polyhedral and spheroidal nanoparticles with a size ranging from about 10 to 100 nm in diameter.

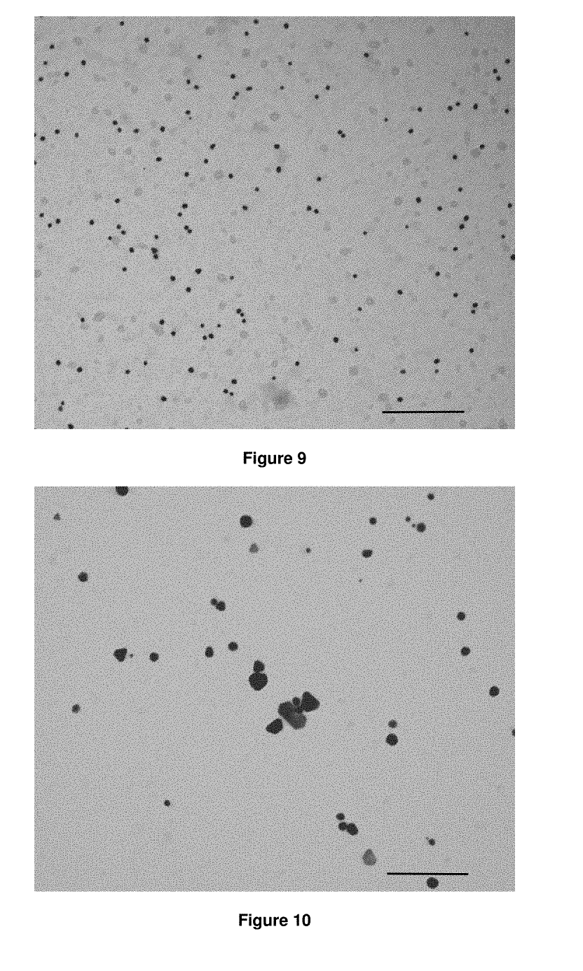

In FIG. 9 it is possible to observe the AuNPs produced with the Pittosporum undulatum seeds or fruits extract. These nanoparticles are very homogeneous in shape and size. Most of them were visualized as spheroid structures with an approximate size between 5 to 10 nm in diameter. In contrast to the above, in FIG. 10 it is possible to observe the AuNPs obtained with the Pittosporum undulatum leaves and stems extract. In this case the nanostructures were more diverse in shape and size, observing triangular, polyhedral and spheroidal AuNPs with a size range from about 5 to 100 nm in diameter.

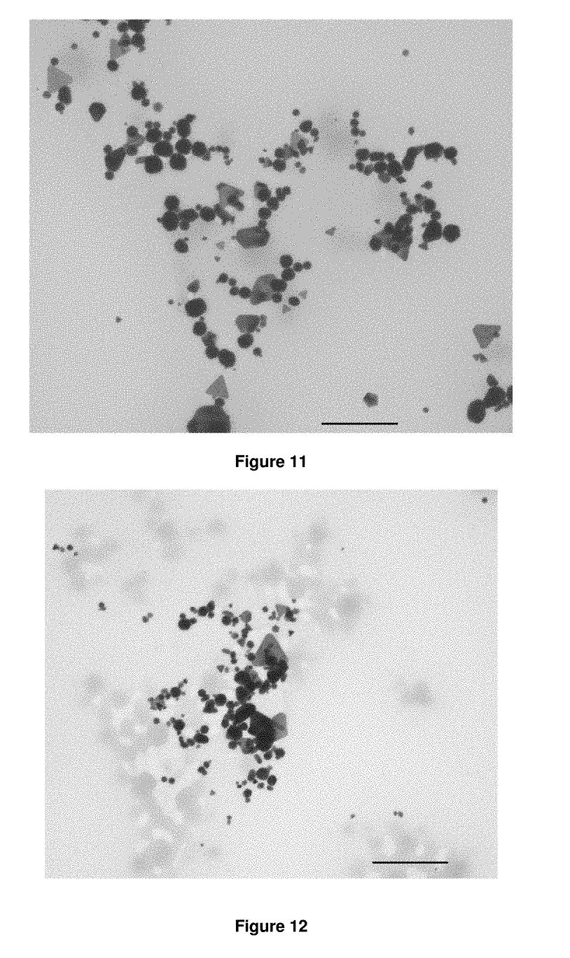

In FIGS. 11 and 12 it is possible to observe the AuNPs produced with pericarpium and mesocarp extract, respectively, from Acca sellowiana fruit. It is noted a great diversity in shapes and sizes. It is possible to observe triangular, pentagonal, hexagonal, polyhedral and spheroidal nanoparticles with a size ranging from about 10 to 100 nm in diameter.

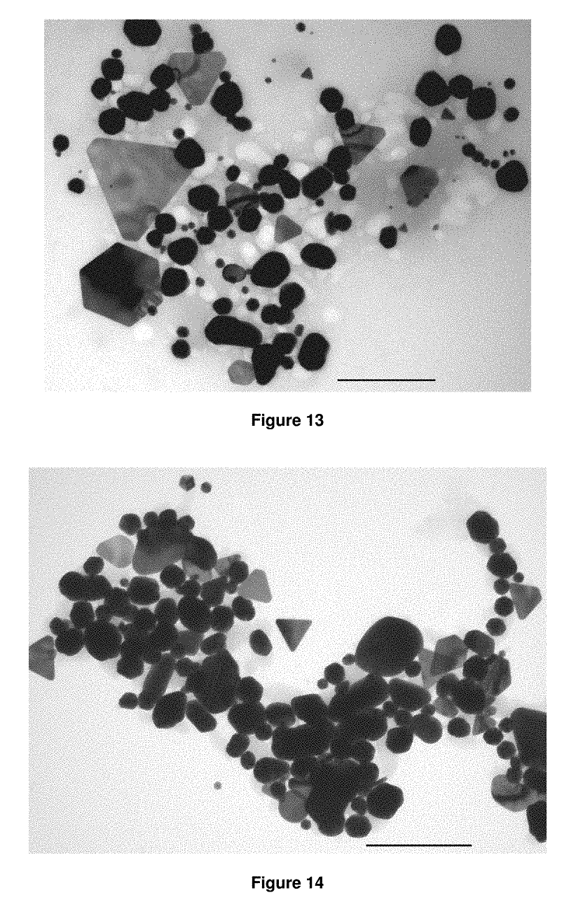

In FIG. 13 it is possible to observe the AuNPs obtained using the Ugni molinae fruit extract. A great diversity of shapes and sizes can be observed. It is possible to visualize triangular, cubic, hexagonal, polyhedral and spheroidal nanoparticles with a size ranging from about 5 to 200 nm in diameter.

Lastly, in FIG. 14 it is possible to observe the AuNPs obtained using the Colliguaja integérrima leaves extract. A great diversity in shape and size is observed. It is possible to visualize triangular, pentagonal, hexagonal, polyhedral and spheroidal nanoparticles with a size ranging from about 10 to 150 nm in diameter.

The results from the transmission electronic microscopy confirm the ability of the Colliguaja salicifolia, Pittosporum undulatum, Acca sellowiana, Ugni molinae or Colliguaja integérrima de vegetable extract to catalyze the gold nanoparticles synthesis from HAuCl₄.

1. Method to obtain gold nanoparticles from plants, said method comprised the steps of:
a) obtaining an extract from the plant;
b) heating said extract;
c) eliminating the insoluble material from said extract;
d) mixing under appropriate conditions the extract soluble material with a substrate comprising a gold salt; and
e) Recovering the gold nanoparticles from said mixture.

2. Method according to claim 1, wherein said extract from a plant is an aqueous extract.

3. Method according to claim 2, wherein the aqueous extract is obtained by maceration from any part of the plant selected from seeds, steams, flowers, leaves, fruits, latex or a combination thereof.

4. Method according to claim 1, wherein said extract is heated until boiling between 1 and 10 minutes.

5. Method according to claim 1, wherein the insoluble material is eliminated by filtration.

6. Method according to claim 1, wherein said gold salt is HAuCl₄.3H₂O.

7. Method according to claim 1, wherein said appropriate conditions include continuously mixing the soluble extract with the substrate comprising the gold salt for 0.5 to 12 hours, at a temperature between 25-27° C.

8. Method according to claim 1, wherein the gold nanoparticles are recovered from said mixture by means of a step selected from low speed centrifugation and sedimentation on standing of the mixture for at least 1 hour.

9. Method according to claim 1, wherein said plant is selected from the group consisting of Colliguaja salicifolia, Pittosporum undulatum, Acca sellowiana, Ugni molinae and Colliguaja integerrima.

10. Gold nanoparticles obtained from Colliguaja salicifolia, Acca sellowiana, Pittosporum undulatum, Ugni molinae, or Colliguaja integerrima.

11. Gold nanoparticles according to claim 10, Pittosporum undulatum and having a spheroidal geometry and a diameter between 5 nm and 10 nm.

12. Gold nanoparticles according to claim 10, obtained from Ugni molinae and having a triangular, cubic, hexagonal, polyhedral, or spheroidal geometry and a diameter of about 5 nm and 200 nm.

13. Gold nanoparticles according to claim 10, obtained from Colliguaja integerrima and having a triangular, pentagonal, hexagonal, polyhedral, or spheroidal geometry and a diameter between 10 nm and 150 nm.

14. A biocatalyst for obtaining gold nanoparticles from plants selected from the group consisting of phenolic compounds triterpenoids, sesquiterpene glucosides, monoterpenes, diterpenes, alkanes, and vitamin C.

15. The biocatalyst of claim 14, wherein the phenolic compounds include flavonoids and tannins.

16. Gold nanoparticles according to claim 10 obtained from Colliguaja salicifolia which have a triangular, pentagonal, hexagonal, polyhedral, or spheroidal geometry and a diameter between 10 nm and 100 nm.
